(19) United States
(12) Patent Application Publication
(10) Pub. No.: US 2010/0030417 A1
(43) Pub. Date: Feb. 4, 2010

(54) ENVIRONMENTAL SURVEY ROBOT

(75) Inventors: HSIN-FA FANG, Taoyuan County (TW); WEI-CHENG YANG, Taoyuan County (TW); ING-JANE CHEN, Taoyuan County (TW)

Correspondence Address: WPAT, PC;INTELLECTUAL PROPERTY ATTORNEYS, 7225 BEVERLY ST., ANNANDALE, VA, 22003, US

(73) Assignee: Institute of Nuclear Energy Research Atomic Energy Council, Executive Yuan, Taoyuan County (TW)

(21) Appl. No.: 12/258,596

(22) Filed: Oct. 27, 2008

(30) Foreign Application Priority Data
Jul. 22, 2008 (TW) 097213032

(51) Int. Cl. G05D 1/00; G05B 15/00

(52) U.S. Cl. 701/25; 700/258; 901/1; 901/46

(57) ABSTRACT

An environmental survey robot suitable for wireless communicating with a survey action management center having a geographic information system to scheme an advance route with multiple check points is provided. The environmental survey robot includes a moving vehicle, a controlling computer, a wireless communication network, a Global positioning system, an environment detector, a solar cell and a power controller. The wireless communication network receives the advance route from the detecting action management center, and the controlling computer autonomously controls the moving vehicle to move in accordance with the advance route. The environmental detector is suitable for detecting the environment information and sending the same to the controlling computer. When the electricity of the solar cell is less than a predetermined value, the power controller will send the signal to the controlling computer such that the action controller will stop the action of the moving vehicle.

### FIELD OF THE INVENTION

The present invention relates to a robot, and more particularly, to an environmental survey robot which is capable of performing the mission of environmental survey and information gathering for a long period of time in a large area at where a human cannot be present on site to perform the mission because it is far away, dangerous, or inaccessible.

### BACKGROUND OF THE INVENTION

The word robot was introduced to the public at large by Czech writer Karel \check{C}apek in his play R.U.R. (Rossum's Universal Robots), which premiered in 1921. The play begins in a factory that makes ‘artificial people’—they are called robots, but are closer to the modern idea of androids or even clones, creatures who can be mistaken for humans. They can plainly think for themselves, though they seem happy to serve. However, it wasn't until the second half of the twentieth century, when integrated circuits were invented, and computers began to double rapidly in power (roughly every two years according to Moore's Law), that it became possible to build robots as we imagine them. Until that time, automatons were the closest things to robots, and while they may have looked humanoid, and their movements were complex, they were not capable of the self-control and decision making that robots are today. Recenty, with the rapid progress in sensing technology and computer performance, more advanced robot can be built which has improved body structure, more agile robotic arms, execellent motrion control ability, good environmental modelling and path planning for automonous motion, innovated remote control ability, and marveous image and audio identification ability. For instnace, an autonomous robot is disclosed in TW Pat. No. I242701 at Mar. 12, 2004, which can plan a path to manuver itself away from an obstacle by the detection of laser radars, ultrasonic set of sensors and imaging devices. Moreover, as there are more and more robots being applied in places where a human cannot be present on site to perform the mission because it is dangerous, far away, or inaccessible, it is required to have robots designed speicified for such “dull, dirty, and dangerous” jobs, such as the robot disclosed in TW Pat. No. M310092 at Sep. 21, 2006, for metal dectection; and the robot disclosed in TW Pat. Appli. No. 200810894, for disaster/danger manangement.

Competitions for robots are gaining popularity, attracting participation from amateurs, private industry, schools and research institutions. Robots compete at a wide range of tasks including destructive combat, non-destructive combat, fire-fighting, maze solving, performing tasks, navigational exercises (eg. the DARPA Grand Challenge) and many others. The DARPA Grand Challenge is a prize competition for driverless cars, sponsored by the Defense Advanced Research Projects Agency (DARPA), the most prominent research organization of the United States Department of Defense. U.S. Congress has authorized DARPA to award cash prizes to create the first fully autonomous ground vehicles capable of completing a substantial off-road course within a limited time that such autonomous ground vehicles are usually configured with Global positioning system (GPS) of centimeter-scaled accuracy, gyroscopic devices and all kinds of set of sensors incluidng optical set of sensors, radar set of sensors and image set of sensors, and thus can be very expensive. However, as the GPS of the aforesaid autonomous ground vehicle can be easily affected by bulidings, trees or even tunnels when it is operating in a mock urban environment, the aforesaid autonomous ground vehicle must be programmed with regional maps of centimeter-scaled accuracy for enabling its controlling computer to plan a path for autonomous movement after massive complex computations. Thus, when there is no regional map available or the accuracy of the regional map is not sufficient, such expensive autonomous ground vehicle is not able to function effectively.

On the other hand, there are many jobs which a human could perform better than a robot but for one reason or another the human either does not want to do it or cannot be present to do the job. The jobs may be too dangerous or may be too boring and dirty to bother with, for example expolring environment for comtammination accessment and evaluation when the envoironment is comtaminated by pollutants. The use of robot to perform such “dull, dirty, and dangerous” jobs has the following advantages: (1) In addition to save manpower, the use of robot to replace human workers can save human worker from having to working in the dangeous comtaminated environmment which can be life threatening; (2) As robot is able to function normally in places that are inaccessible to human workers, the range of survey area for comtamination evaluation can be enlarged; (3) As robot is able to stay in a satndby mode tirelessly for a long period of time and can be remotely controlled in group, it is adapted to cope with certain environmental emergency; (4) As human workers are prone to make mistake in haste, the consistency of robot as well as its control will ensure the survey quality of the comtammination accessment.

It is noted that a good robot is a practical and economical robot whose design is optimized in accordance with its functions, and is not blindly in pursue of adding most advanced device. In a disastrous environmental pollution event, the area that is contaminated may be huge and the same time that it may require to be monitored for a long period of time. For instance, in an environmental pollution event such as the Chernobyl nuclear disaster in former Soviet Unit or the poisonous gas leaking case in India, Bhopal, the radius of the contaminated area may be more than several tens of kilometers and must be monitored and surveyed continuously for days, months and years. Nevertheless, as all the currently available autonomous ground robots that are capable of operating outdoors are not designed to working consistently for a long period of time, not to mention that they are bulky, expensive and complex in structure, they are not suitable for environmental survey tasks.

Any robot capable of performing pollution survey in such a huge area not only has to be mounted with environmental detectors for a variety of pollutants and being able to communicate with environment assessment devices, but also must equipped the following abilities: (1) improved remote control ability; (2) long range navigation and positioning method adapted for uncharted area; (3) ability to sustain normal operation for a long period of time so as to enable the robot to cover a larger area; (4) ability to receive a new command remotely; (5) ability to call for help when the robot is damaged. In view of the aforesaid description, it is preferred to have a solar-powered robot that is able to communicate wirelessly through a wireless communication network, such as UMTS, HSDPA, HSUPA, WiMax, or B3G, and is configured with a Global positioning system (GPS) integrating information from a Geographic information system (GIS), by which an optimal advance route can be schemed in a survey action management center with reference to a meter-scaled map provided from the Geographic information system (GIS), and thus the robot is able to advance autonomously following the schemed route while being double checked at multiple check points according to position information from its GPS for confirming its locations.

Although those currently available wireless communication networks are capable of realizing high speed network communication, its communication stability is still less than on-site direct remote control. The robot are designed to download the survey plan and route from the survey management center before beginning to work that could avoid the problem caused by the remote control range out of view and the wireless communication network out of service . . . . In addition, as most conventional robots use odometer, compass and gyroscope to identify its position, such positioning can have little error is short distance but those little errors could be accumulated and become unbearable in long range. Moreover, most commercial GPS products are only good for an accuracy of about ten meters, and are easily affected by terrain, surface features, and buildings. Other than that, the situation that the robot is operating at night but there is no sun to charge its solar cell, and the situation that the capacity of battery carried on the robot is limited by the load capacity of the robot, are all difficulties must be considered.

Therefore, it is in need of a practical and economical environmental survey robot that is capable of performing a mission of environmental survey and information gathering for a long period of time in a large area at where a human cannot be present on site to perform the mission because it is far away, dangerous, or inaccessible.

### SUMMARY OF THE INVENTION

The object of the present invention is to provide an environmental survey robot, which is capable of communicate wirelessly through a wireless communication network for enabling the robot to be controlled remotely and to transmit its survey result in real time; and is capable of operating for a long period of time as it is being powered by solar cell; and is capable of using a geographic information system to scheme an survey route composed of multiple legs and multiple check points according to a specific mission, such as to have less obstacles on the route or to receive most intense sun shine on the route, while using a electric map of the GIS to display the location of the robot and its survey result simultaneously; and is capable of moving autonomously on one leg after another on the advance route according to the navigation of an orientation sensing device and a gyroscopic device while executing a survey each time when the robot finish its autonomous moving on one leg of the multiple legs in the survey route given by a Global positioning system (GPS) Thereby, the environmental survey robot is designed to replace humans for executing a job of environmental pollution exploration as it has the following advantages: it is able to send back its location and survey results data in real time; since the robot is able to function without having to put personnel in dangerous contaminated area, the survey area can be widened while the time for performing the environmental exploration job can be prolonged; and as robot is able to stay in a satndby mode tirelessly for a long period of time, it is adapted to cope with certain environmental emergency, and thus the survey quality of the comtammination accessment can be ensured.

To achieve the above object, the present invention provides an environmental survey robot, suitable for wireless communicating with a survey action management center, embedded with a geographic information system, to scheme an survey route with multiple check points, which comprises: a moving vehicle, a global positioning system, a controlling computer, an environmental detector, a solar cell, a power controller, and a wireless communication network; wherein the moving vehicle further comprises: a frame, a set of set of sensors, and a motion controller. As soon as the survey action management center had provided a survey plan and use its geographic information system to scheme an advance route composed of multiple legs as well as a corresponding leg-by-leg exploring method, the advance route and leg-by-leg exploring method are transmitted to the controlling computer through the wireless communication network for directing the controlling computer to issue commands to the motion controller and the environmental detector so as to control the robot to move and detect according to the survey plan. In addition, signals generated from the motion controller, the environmental detector and the solar cell are capable of being transmitted to the controlling computer where they are being send to the survey action management center through the wireless communication network for informing the survey action management center about the working status rof the robot. Moreover, the motion controller, the set of sensors, the controlling computer, the environmental detector, the solar cell and the power controller are mounted on or configured inside the moving vehicle. In an exemplary embodiment, the motion controller, the set of sensors, and the frame can be integrated as a device which substantially is the moving vehicle. The motion controller is electrically connected to the frame to be used for controlling the movement of the frame. The set of sensors is designed to send signals to the motion controller where the signals not only are analyzed to be used as reference of motion control, but also are transmitted to the survey action management center. The environmental detector is used for acquired information relating to any pollutant existed in the detected environment while transmitting its survey result to the controlling computer.

In an exemplary embodiment, the power controller is used for controlling the battery to be used as the power source for the controlling computer, the environmental detector and the moving vehicle according the capacity of battery and the working state of solar cell. It is noted that the GPS and the wireless communication network could be powered by the environmental detector and the controlling computer at which there are connected in respective through a universal serial bus (USB) interface. In addition, as the power controller is designed to receive logistic and commands from the controlling computer, the controlling computer is able to issue a stop command to the power controller for stop feeding power to the moving vehicle and thus stop the moving of the robot when the robot had reached a location where it is schemed to be surveyed, and thereby, the power saved from the above action can be used for sustaining the environmental detector to operate for a longer period of time; and on the other hand, the power controller can stop feeding power to the environmental detector also according to the command of the controlling computer when the robot is moving along one leg of the advance route. Moreover, when the power controller detects that the amount of electricity stored in the battery is less than a specific amount, it will adopt a power supply measure for supplying power to the controlling computer in an intermittent manner, such as once an hour or once a day; or when the robot is plan to execute a long distance survey and the power controller detects that the amount of electricity stored in the battery is less than a specific amount, the power controller will stop the moving vehicle until sufficient electricity had been generated by the solar cell so as to prevent the battery from being damaged by overuse and thus can not be charged again.

In an exemplary embodiment, the survey action management center is designed to provided a survey plan including scheming an advance route for the robot and scheduling the survey of the robot on the advance route; and is able to transmit the survey plan to the environmental survey robot through the wireless communication network. As any such environmental survey robot is able to move and operate autonomously after it had received the survey plan from the survey action management center, the survey action management center is able to send survey plans to multiple environmental survey robots at the same time. In addition, the wireless communication network is a network selected from the group consisting of: HSDPA, WiMax, B3G, and 4G.

In an exemplary embodiment, the GIS of the survey action management center is embedded with geographic maps and designed with a geographic information gathering ability, by which an optimal advance route with less obstacles can be schemed while specifying several specific locations on the route for GPS calibration, such as the turning of the route, an intersection on the route, etc., and thus the robot is able to advance autonomously following the schemed route while being double checked at multiple check points according to position information from its GPS for confirming its locations. It is noted that the advance route provided by the GIS can be adjusted according to actual requirement, human judgment, or automatically.

In an exemplary embodiment, the controlling computer is designed to convert the multiple legs and check points in the schemed survey plan into moving commands and then transmits to the motion controller for enabling the motion controller to direct the moving vehicle to move autonomously and to determined whether the robot had reached one of the check points with reference to the information from the set of sensors. When the robot reaches one check points, the motion controller will issue a signal to the controlling computer for enabling the controlling computer to use its GPS to compare relating data so as to perform a double-check operation for determining whether the robot had actually reached the check point, so that, at the end of each leg in the advance route, the location of the robot is calibrate for minimizing the error happening in the long-range autonomous moving of the robot.

In an exemplary embodiment, the moving commands relating to the converting of the multiple legs and check points in the schemed survey plan by the controlling computer are provided to the motion controller separately and in batch according to the memory of the motion controller so that the performance of the motion controller can be ensured.

In an exemplary embodiment, the location of the environmental survey robot on the advance route can be identified by the controlling computer by the use of GPS and the motion controller and then the controlling computer can send the information combining the location and the survey result from the environmental detector to the survey action management center through the wireless communication network for enabling the combined information to be displayed on the electric map of the GIS. It is noted that the location of the robot can still be identified even when it enters a position which can not be located by GPS, such as tunnel.

In an exemplary embodiment, the motion controller can be stopped when it reaches the end of its advance route or reaches a position where it is impossible to move any further according to the route, and then is programmed to issue a signal to the controlling computer which is then feed the signal to the survey action management center through the wireless communication network for asking further direction.

In an exemplary embodiment, the GIS has a relational database which not only is used for storing and displaying the survey results from the controlling computer, but also being configured with a multi-layered geographic map which is capable of constructing an electric map according to the latest survey result while enabling the current displayed electric maps in the multi-layered geographic map to be changed to the newly constructed map after being displayed for a specific period of time.

In an exemplary embodiment, the environmental detector further comprises an detector and a signal decoder; by which the signal of the detector is decoded by the signal decoder into a signal recognizable by the controlling computer. In addition, the detector is able to detect the amount of radiation dose rate, radionuclides gaseous pollutants, volatile organic compounds (VOCs) or aerosol particles in the environment.

In an exemplary embodiment, the moving vehicle, comprising the motion controller, the set of sensors and the frame, is able to move autonomously; and the set of sensors, comprising a radar, a LiDAR, an imaging device, a gyroscopic device, a compass, a odometer, and so on, is used to assist the autonomous moving of the robot and thus is designed to send a signal generated therefrom to the motion controller; and the frame includes the shell, the framework and the chassis of the robot.

To sum up, the environmental survey robot is able to move autonomously into a contaminated area where it is potentially dangerous to human being so that an environmental survey operation can be performed without having to subject human operators in hazardous situations. In addition, the environmental survey robot is able to determine whether it is going to stop moving on its own as soon as the amount of electricity stored in its battery is less than a specific amount and wait until sufficient electricity had been generated by the solar cell and then restart the moving of the robot. It is noted that when the robot is stopped, its environment detector is kept operating for detecting information relating to its ambient environment while sending the detected information to the survey action management center.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a block diagram showing an environmental survey robot according to an exemplary embodiment of the invention.

FIG. 2 is a schematic diagram showing how the position of an environmental survey robot is located according to an exemplary embodiment of the invention.

FIG. 3 is a schematic diagram showing how the power of an environmental survey robot is managed according to an exemplary embodiment of the invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows

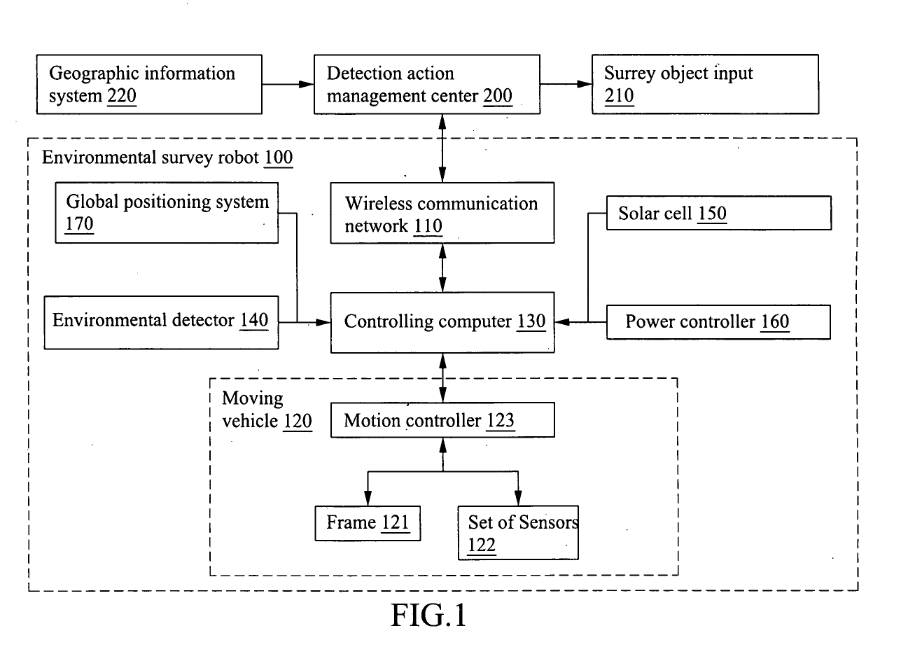

Please refer to FIG. 1, which is a block diagram showing an environmental survey robot according to an exemplary embodiment of the invention. As shown in FIG. 1, the environmental survey robot 100 comprises: a wireless communication network 110, a moving vehicle 120, a controlling computer 130, an environment detector 140, a solar cell 150, a power controller 160 and a Global positioning system (GPS) 170; in which the controlling computer 130, the environmental detector 140, the solar cell 150, the power controller 160 and the Global positioning system (GPS) 170 are all mount on or configured inside the moving vehicle 120. In addition, the moving vehicle 120 is composed of a frame 121, a set of sensors 122 and a motion controller 123, by which the environmental survey robot 100 is able to move while being directed by the controlling computer 130 to maneuver around obstacles. Moreover, the survey action management center 200, as the one shown in FIG. 1 that is capable of communicating with the environmental survey robot 100 through the wireless communication network 110, includes an Survey object input 210 and a geographic information system 220.

The motion controller 123 in the moving vehicle 120 is electrically connected to the frame for controlling the same to move and thus enabling the robot to advance, back off or negotiate a turn as required. Therefore, the frame is composed of a powered motion device, a framework, and a shell, in which the powered motion device has a mechanical sub-system and an electrical sub-system. Generally, the mechanical sub-system includes those mechanical components required in the robot for achieving whatever it is designed to accomplish, such as gear sets and actuators; and the electrical sub-system includes those electric components required for driving the mechanical components, such as power supply. The set of sensors 122 is used for providing a feedback signal to the motion controller 123 for informing the same with information relating to the location of the robot, the size of object existed in the neighborhood of the robot, or the distance between the robot and its surrounding object, and so on. In a preferred embodiment, the set of sensors 122 can be the radar, the LiDAR, the imaging device, the gyroscopic device, the compass, the odometer, the combination of the above sensors, whichever can provide useful information to assist the robot to move. The motion controller 123 is programmed with all the operation sequence required in the robot for achieving whatever it is designed to accomplish that it can issue commands to all kinds of actuators, set of sensors while receiving the feedback signal from the set of sensors 122 and thus capable of functioning as an intelligent job aid for helping the robot to carry on all kinds of tasks, such as scheming a route or preventing collisions, and so on. The moving vehicle 120 is designed to receive commands from the controlling computer 130 relating to the advance route schemed by the survey action management center 200 and is capable of finishing the route in a leg-by-leg manner while issuing a finish signal to the controlling computer 130 as soon as it reaches the end of the route and the same time enabling the GPS 170 to identify the robot's current position for double-checking.

It is noted that the command received by the moving vehicle 120 is originated from the survey action management center 200. The communication between the controlling computer 130 and the survey action management center 200 is enabled by a network so that the survey action management center 200 must maintain a fixed IP linkage with the network in a wired or wireless manner; and the controlling computer 130 is designed to use a wireless communication network, which is a network selected from the group consisting of: 3G, HSDPA, WiMax, B3G, and 4G, to connect with the Internet for enabling the same to move freely while being able to be controlled remotely. It is noted that when the moving vehicle 120 is only required to be remotely control with in a short range, i.e. within about a hundred meter, the network such as WiFi and Zigbee can be used. In addition, the network is not restricted to be internet, intranet or VPN.

The function of the network is not only being used for receiving/transmitting signals from the survey action management center 200, but also can be used for transmitting signals gathered from the moving vehicle 120, the environmental detector 140, the solar cell 150, the power controller 160 and the GPS 170 to the survey action management center 200.

The survey action management center 200 is designed to control the robot 100 in an indirect manner, i.e. the action of the robot 100 is not monitored by the survey action management center 200 at all time for enabling the survey action management center 200 to control the robot 100 in real time, but instead, after the survey plan and route schemed by the survey action management center 200 is transmitted to the robot 100 through the network, the environmental survey robot 100 is going to finish the survey autonomously without being monitored. In another word, after an advance route with multiple check points is being schemed by the survey action management center 200 with the help of its geographic information system 220, the route is transmitted to the environmental survey robot 100 and then the robot 100 will walk linearly and sequentially along each leg on the route between two successive check points while double-checking its location at the end of each leg with reference to the GPS information. As the survey action management center 200 in operating in the aforesaid “fire-and-forget” manner, it is able to command more than one environmental survey robots 100 simultaneously. However, since the moving vehicles 120 of different robots 100 can be fabricated by different manufacturers using different techniques, the command recognizable by different moving vehicles 120 can be different so that it is required to have a controlling computer 130 for converting commands from the survey action management center 200 into signals recognizable by its corresponding motion controller 123.

Therefore, as the advance route planning is accomplished manually or by complex computer calculation in the survey action management center 200 with the help of its geographic information system 220, it can ensure that the majority of the route will travel on terrain with little obstacles, such as on a well-paved road or on level ground and thus there is only a small portion in the route that is difficult to travel and is required to overcome by the robot 100. Thus, the works of the robot 100 do not contain the complex route planning and only focus on the advance of the survey route. The manufacturing cost of the environmental survey robot 100 is reduced greatly as well as its energy consumption. Moreover, also because that the complex route planning is accomplished in the survey action management center 200 where power management in not a problem, it can configured with a high-speed computer system for scheming the advance route for each and every robot in a one-by-one manner.

In an exemplary embodiment, the moving commands relating to the converting of the multiple legs and check points in the schemed survey route plan by the controlling computer 130 are provided to the motion controller 123 of the moving vehicle 120 separately and in batch according to the memory of the motion controller 123 so that the performance of the motion controller 123 can be ensured. That is, each time when the robot reaches the end of one leg of the route and the controlling computer 130 had finished its checking by the help of GPS 170, a new command relating to the next leg is then issued to the motion controller 123.

Moreover, as soon as the environmental survey robot 100 reaches one check point, the location of such check point will be double-checked with reference to the location information from the GPS 170. If the double-checking confirms an error, a re-checking operation will be executed using the GPS information while the controlling computer 130 will automatically transmit the information relating to the error to the survey action management center 200. If the re-checking still confirms the error, the controlling computer will calculate the orientation and the distance differences between the GPS information and the check pint so as to provide a calibration command to the motion controller 123 for eliminating the error.

The Survey object input 210 is used for identify the coordinate of a target area that is required to be surveyed and thus inputting the geographic coordinate along with the focus of the survey into the survey action management center 200. The environmental survey robot 100 that is already on-line is able to transmit its geographic coordinate to the survey action management center 200 through network by the signal gathering of its GPS 170. Thereby, the geographic information system 220 is able to perform an analysis for scheming out an optimal route for directing the robot 100 to move toward the target area according to the coordinates of the target area and the robot 100.

The optical route obtained from the analysis of the geographic information system 220 should be represented in a 2-degree transverse Mercator coordinate system for facilitating the controlling computer 130 to convert the same into commands recognizable by the motion controller 123. It is noted that if the available geographic coordinates of the he target area and the robot 100 are not represented in the 2-degree transverse Mercator coordinate system, the geographic information system 220 will first convert the two geographic coordinates to conform to the 2-degree transverse Mercator coordinate system before carrying out the analysis. It is noted that the 2-degree transverse Mercator coordinate system is a grid-based method of specifying locations on the surface of the Earth. It is used to identify locations on the earth in a Cratesian coordinate system of X- and Y-axises, as it use decimal in unit of meters which is differs from the traditional method of latitude and longitude in sexagenary. Thus, if the GPS information is represented in the traditional method of latitude and longitude, it will require the controllingn computer 130 to spend time and resource for converting the GPS information into the 2-degree transverse Mercator coordinate system, so that the GPS 170 should be designed to output the GPS information in the 2-degree transverse Mercator coordinate system.

From the above description, it is noted all kinds of geographic information can be gathered by the geographic information system 220, including roads, bridges, tunnels, surface inclinations, which are used in the analysis as reference for acquiring the optimal route with least obstacles.

In addition, the location and geographic information from the environmental detector 140, the GPS 170 and the moving vehicle, as they are integrated by the controlling computer 130, can be gathered by the geographic information system 220 and displayed on an electric map, from which the survey action management center 200 is able to know the location of the environmental survey robot as well as its survey result visually.

In an exemplary embodiment, the environmental detector 140 further comprises an detector and a signal decoder; by which the signal of the detector is decoded by the signal decoder into a signal recognizable by the controlling computer 130. In addition, the detector is able to detect the amount of radiation, gaseous pollutants, volatile organic compounds (VOCs) or aerosol particles in the environment.

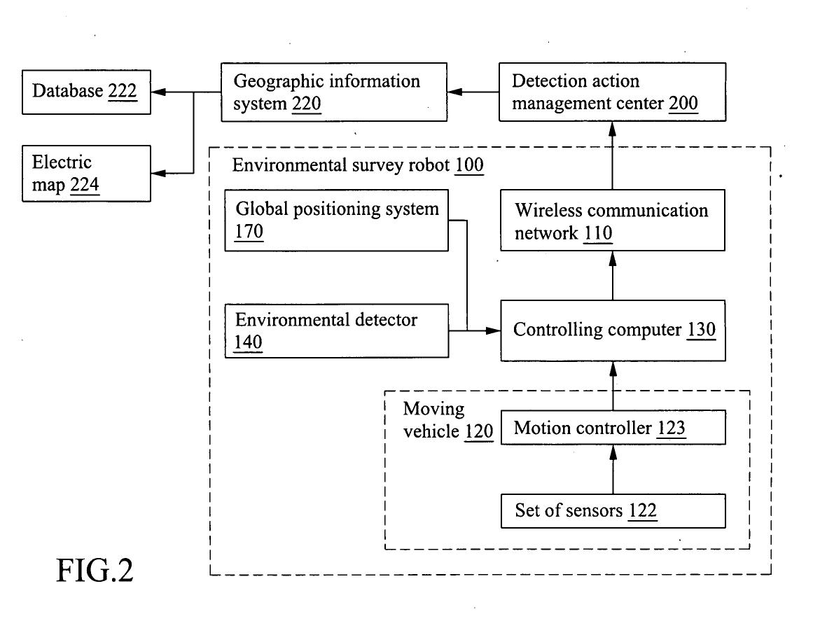

Please refer to FIG. 2, which is a schematic diagram showing how the position of an environmental survey robot is located according to an exemplary embodiment of the invention. As soon as the controlling computer 130 receives the environment information detected by its environment detector 140, it will combine the environment information with the location information of the environmental survey robot 100 while transmitting the combined information to the survey action management center 200 at which the combined information not only will be stored in the database 222 of the geographic information system 220, but also will be display on its electric map 224. Generally the location of the environmental survey robot 100 is the one obtained from the Global positioning system 170. In addition, the geographic information system 220 can also provide a standard time to the controlling computer 130 for time calibration that it can be helpful for integrating the survey results of different environmental survey robot 100 for displaying. However, in some situations that when the environmental survey robot 100 is in a tunnel or under the shielding of buildings, the GPS 170 will not be able to identify the robot's location and thus the location information is then being provided by the moving vehicle 120. As such, by combining the GPS information before the environmental survey robot 100 enters a position where is not detectable by the GPS 170 and the time that the environmental survey robot 100 is traveling after entering such position, the current location of the environmental survey robot 100 can extrapolated.

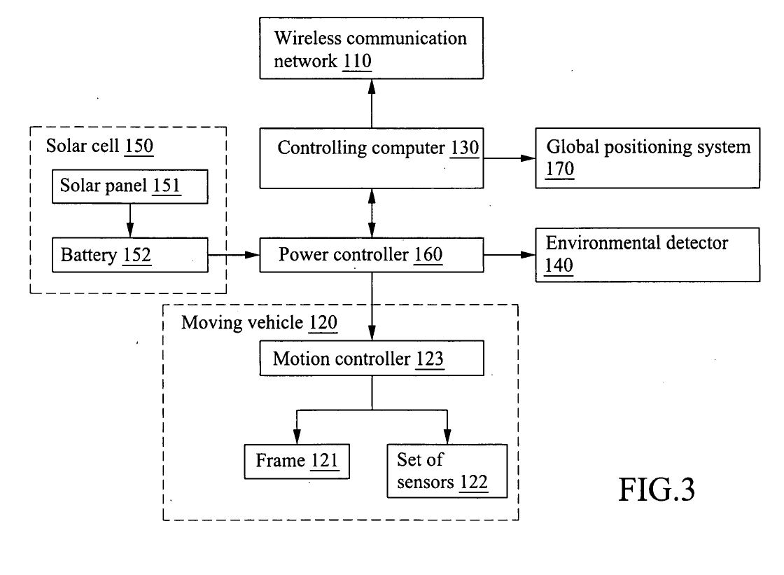

Please refer to FIG. 3, which is a schematic diagram showing how the power of an environmental survey robot is managed according to an exemplary embodiment of the invention. As shown in FIG. 3, the solar cell 150 is composed of a solar panel 151 and a battery 152. The solar panel 151 can continuously convert solar energy into electricity and then store the same in the battery 152, from which electricity is feed to the moving vehicle 120, the controlling computer 130, the environmental detector 140 through the power controller 160 for sustaining the same to operate. Moreover, as the wireless communication network and the GPS 170 are connected to the controlling computer 130 through corresponding universal serial bus (USB), they can be powered by the controlling computer 130, but also they can be powered by the battery 152 through the power controller 160 if necessary.

As the power controller 160 is used for managing the electricity in the battery 152, it is designed with the ability to measure the voltage of the battery 152 as well as the ability to determine how and where the electricity of the battery 152 should be supplied. For instance, the power controller 160 can stop feeding power to the moving vehicle 120 and thus stop the moving of the robot 100 when the robot 100 had reached a location where it is schemed to be surveyed, and thereby, the power saved from the above action can be used for sustaining the environmental detector 140 to operate for a longer period of time; and on the other hand, the power controller 160 can stop feeding power to the environmental detector the environmental detector 140 a when the robot 100 is moving along the advance route as no environmental surveys required.

However, the environmental survey robot 100 can be designed to move while performing environmental survey. Thus, when the amount of electricity stored in the battery 152 is less than a specific amount, the power controller 160 will stop the moving vehicle until sufficient electricity had been generated by the solar cell 150 so that it can prevent the electricity in the battery 152 from wasting in moving and thus be used in environment survey which is the priority for the robot 100. As soon as the stored electricity in the battery 152 is higher than the specific amount, the power controller 160 will issue a signal to the controlling computer 130 for informing the same to direct the moving vehicle 120 to move again.

In an exemplary embodiment, the specific amount of electricity is inputted in the power controller 160 by the survey action management center 200, as shown in FIG. 1.

From the above description, it is note that the environmental survey robot is able to move autonomously into a contaminated area where it is potentially dangerous to human being so that an environmental survey operation can be performed in high efficiency without having to subject human operators in hazardous situations.

To sum up, the environmental survey robot of the invention has the following advantages:
(1) The survey action management center is designed to communicate with the environmental survey robot through network for issuing survey commands in an “fire-and-forget” manner and each environmental survey robot can function autonomously after receiving commands and only report to the survey action management center when runs into problems, the survey action management center is able to command more than one environmental survey robots simultaneously.
(2) As the location and geographic information from the environmental survey robot are feed back to the the geographic information system of the survey action management center by which such information are displayed on an electric map, the survey action management center 200 is able to know the location of the environmental survey robot as well as its survey result visually.
(3) It is noted that the controlling computer is enabled to use the GPS information relating to the location of the robot to check whether the moving vehicle actually reaches the check points while allowing a specific uncertainty; and as the advance route is divided into multiple legs by the plural check points and, at the end of each leg, the aforesaid comparison is perform so as to calibrate the location of the moving vehicle and thus the error resulting from the long-range autonomous moving of the moving vehicle is minimized.
(4) By the power management and the use of solar cell, the environmental survey robot of the invention is able to operate outdoors effectively for a long period of time.
(5) It is note that the environmental survey robot is able to move autonomously into a contaminated area where it is potentially dangerous to human being so that an environmental survey operation can be performed in high efficiency without having to subject human operators in hazardous situations.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An environmental survey robot, suitable for wireless communicating with a survey action management center having a geographic information system to scheme an advance route, the environmental survey robot comprising:
a moving vehicle, for carrying the environmental survey robot to move;
a controlling computer, electrically connected to the moving vehicle;
a wireless communication network, electrically connected to the controlling computer to be used thereby for receiving the advance route from the survey action management center so as to direct the moving vehicle to move autonomously along the advance route;
a Global positioning system (GPS), for transmitting an information relating to the location of the environmental survey robot to the controlling computer for checking;
an environment detector, electrically connected to the controlling computer, for detecting an environmental information from an ambient environment of the robot while transmitting the detected environmental information to the controlling computer;
a solar cell, electrical connected to the controlling computer for powering the same; and
a power controller, electrical connected to the solar cell and the controlling computer in a manner that the power controller is enabled to issue a signal to the controlling computer for stopping the moving vehicle when the amount of electricity stored in a battery of the solar cell is less than a specific amount.

2. The environmental survey robot of claim 1, wherein the advance route is embedded with a plurality of check points for directing the moving vehicle to move linearly from one check point to another check point next thereto on the route.

3. The environmental survey robot of claim 2, wherein when the moving vehicle is moved autonomously to the next check point by the control of the controlling computer, the controlling computer is enabled to perform a comparison for comparing the location of the next check point with the GPS information relating to the location of the robot.

4. The environmental survey robot of claim 3, wherein each of the plural check points is a location on the advance route with a specific feature selected from the group consisting of: a turning of the route, an intersection on the route, a land mark on the route; and the information relating to the location on the advance route with a specific feature is provided by a geographic information system (GIS).

5. The environmental survey robot of claim 3, wherein the controlling computer is enabled to use the GPS information relating to the location of the robot to check whether the moving vehicle actually reaches the next check points while allowing a specific uncertainty; and as the advance route is divided into multiple legs by the plural check points and, at the end of each leg, the aforesaid comparison is perform so as to calibrate the location of the moving vehicle and thus the error resulting from the long-range autonomous moving of the moving vehicle is minimized.

6. The environmental survey robot of claim 1, wherein the environmental detector is a radiation detector, and the environmental information is a signal of radiation value.

7. The environmental survey robot of claim 1, wherein the environmental detector is a gas detector adapted for detecting the concentration of a gas selected from the group consisting of fuel gas, methane, and hydrogen sulfide; and the environmental information is a signal of gas concentration.

8. The environmental survey robot of claim 1, wherein the moving vehicle further comprises:
a frame, capable of moving;
a motion controller, connected to the frame for receiving commands from the controlling computer to direct the moving of the moving vehicle; and
a set of sensors, connected to the motion controller.

9. The environmental survey robot of claim 7, wherein the set of sensors is a device selected from the group consisting of: an image set of sensors, a radar set of sensors, and an infrared set of sensors.

10. The environmental survey robot of claim 1, wherein the wireless communication network is a network selected from the group consisting of: WiFi, WiMax, UMTS, HSDPA, B3G, and 4G.

11. The environmental survey robot of claim 1, wherein when the amount of electricity stored in the battery of the solar cell is less than the specific amount, the environmental detector is still able to perform the detecting of the environmental information from the ambient environment of the robot.

12. The environmental survey robot of claim 1, wherein when the amount of electricity stored in the battery of the solar cell is less than the specific amount; the solar cell will adopt a power supply measure for supplying power to the controlling computer in an intermittent manner.
